(19) United States
(12) Patent Application Publication
(10) Pub. No.: US 2008/0235222 A1
(43) Pub. Date: Sep. 25, 2008

(54) SYSTEM AND METHOD FOR MEASURING SIMILARITY OF SEQUENCES WITH MULTIPLE ATTRIBUTES

(76) Inventor: Aleksandra Mojsilovic, New York, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/689,490

(22) Filed: Mar. 21, 2007

(51) Int. Cl. G06F 17/30; G06F 7/00

(52) U.S. Cl. 707/6; 707/102; 707/E17.014; 707/E17.005

(57) ABSTRACT

A method (and structure) for quantifying an ordered sequence of data, includes receiving data of the ordered sequence and determining a skeleton of the ordered sequence. The skeleton includes a plurality of perceptually important points (PIPs) of the ordered sequence, as derived by determining one or more points of local maxima of the data over the ordered sequence.

### BACKGROUND OF THE INVENTION

1. Field of the Invention

The present invention generally relates to representing time sequences for such purposes as recognition, analysis, comparison, and relationship discovery. More specifically, a perceptual skeleton is derived by determining the perceptually important points (PIPs), as being points of any number of different orders of maxima, to provide a method to measure such time sequences, including similarity between two different sequences.

2. Description of the Related Art

A temporal sequence (e.g., time series or time sequence) is a sequence of values measured at certain time intervals. The time intervals may or may not be equally spaced. Non-limiting examples include stock market data and exchange rates, biomedical measurements, weather data, history of product sales, audio, video, etc.

Time series constitute a large portion of the data stored in computers and the ability to efficiently search and organize such data is of growing importance in many applications. As a result, significant effort has been directed towards developing methods that will enable computers to assist users in performing tasks such as: “find companies with similar stock prices”, “find portfolios that behave similarly”, “find products with similar sell cycles”, “cluster users with similar credit card utilization”, or “search for music.”

Prior works by others in this area include the application of the Discrete Fourier Transform, Discrete Wavelet Transform, Principal Component Analysis or Linear Predictive Coding cepstrum representation to reduce sequences into points in low dimensional space and the use of the Euclidean distance between two sequences as a measure of similarity.

However, there are many similarity queries where Euclidean distances fail to capture the notion of similarity. A more intuitive idea has been explored that two series should be considered similar if they have enough non-overlapping time-ordered pairs of similar subsequences. In another approach, a set of linear transformations on the Fourier series representation of a sequence is used as a basis for similarity measurement, while yet another approach used a time warping distance.

A special class of problem is the analysis of multivariate time series. Examples of such series include electroencephalograms (where the EEG measurements are recorded up to dozens of channels), weather data (with daily measurements of temperature, humidity, atmospheric pressure and wind), and stock market portfolios (with multiple stocks tracked over a period of time).

In one method, Taniguchi showed that similarities and differences between multivariate stationary time series can be characterized in terms of the structure of the covariance or spectral matrices. In another method, Huan, et al. proposed using a library of smooth localized complex exponentials (SLEX) to extract computationally efficient local features of non-stationary time series.

A separate area of research has focused on the design of feature sets that will allow for more effective and “perceptually tuned” representation of time series based on the extraction of key features, event detection, and extraction of important points.

These techniques are especially interesting, as they attempt to capture the notion of similarity from the perspective of human observer. However, most of these perceptual techniques have difficulties handling multivariate data.

Thus, a need continues to exist for an apparatus, tool, and method of deriving a simple, compressed perceptual representation of multivariate time series and using it as a basis for efficient indexing and similarity search. The present invention addresses this need.

### SUMMARY OF THE INVENTION

In view of the foregoing, and other, exemplary problems, drawbacks, and disadvantages of the conventional systems, it is an exemplary feature of the present invention to provide a structure (and method) in which an ordered sequence of data can be quantifiably represented in a manner similar to visual analysis by humans.

It is another exemplary feature of the present invention to provide a structure and method for comparing two ordered sequences of data in a manner similar to visual comparison by humans.

It is another exemplary feature of the present invention to provide a computerized method that mimics the visual processing by humans when performing functions involving visual representations of ordered sequences and does so in a manner that provides quantitative measurements for comparison purposes.

Thus, in a first exemplary aspect of the present invention, to achieve the above features and objects, described herein is a computer configured to execute a process of quantifying an ordered sequence of data, including a data receiver to receive data of the ordered sequence and a calculator to determine a skeleton of the ordered sequence, wherein the skeleton comprises a plurality of perceptually important points (PIPs) of the ordered sequence, as derived by determining one or more points of local maxima of the data over the ordered sequence.

In a second exemplary aspect of the present invention, also described herein is a computerized method to determine a skeleton of an ordered sequence of data.

In a third exemplary aspect of the present invention, also described herein is a signal-bearing medium tangibly embodying a program of machine-readable instructions executable by a digital processing apparatus to perform the computerize method of quantifying an ordered sequence of data.

As will be explained in more detail, the present invention, therefore, provides the capability of an efficient compression of a time signal, compression and representation in accordance with human visual system, simplification of a signal for efficient indexing, matching, similarity measurement and retrieval.

There are many potential applications of the technique of the present invention, since any ordered sequence of data could be used for input data. Possible applications include, for example: financial analysis and portfolio optimization; storage, indexing, and searching of medical signals and information, speech, music, seismological signals, and/or weather and climate data; business and marketing analytics, such as analyzing product lifecycle, looking for products with similar lifecycles, looking for customers with similar behavior over time or other data mining, etc.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a flowchart 100 of an exemplary embodiment of the present invention;

FIG. 2 shows visually the concept and derivation 200 of a perceptual skeleton 203 of exemplary waveform 201;

FIG. 3 shows the method 300 of deriving the perceptually important points (PIPs) of the waveform 201;

FIG. 4 shows a flowchart 400 of the process of deriving the PIPs of the present invention;

FIG. 5 shows derivation of PIPs for an exemplary multidimensional waveform 500;

FIG. 6 shows an exemplary embodiment 600 for measuring similarity of perceptual skeletons of three signals 601,602,603;

FIG. 7 shows three stock series 700 discussed for demonstration of an application of the method of the present invention;

FIG. 8 shows an exemplary block diagram 800 of a software-based system for a software tool that implements the methods of the present invention;

FIG. 9 illustrates an exemplary hardware/information handling system 900 for incorporating the present invention therein; and

FIG. 10 illustrates a signal bearing medium 1000 (e.g., storage medium) for storing steps of a program of a method according to the present invention.

### DETAILED DESCRIPTION OF AN EXEMPLARY EMBODIMENT OF THE INVENTION

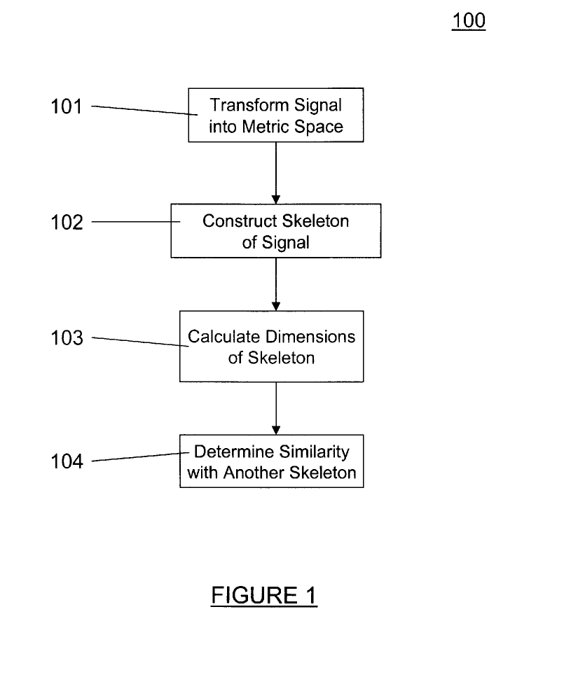

Referring now to the drawings, and more particularly to FIGS. 1-10, an exemplary embodiment of the method and structures according to the present invention will now be described.

Algorithms that attempt to capture some elements of human perception and behavior have often shown excellent results in many applications. When performing similarity measurements, humans mine visual data extensively to construct a representation that captures the most important aspects of a signal, the nature of the application and the task that needs to be achieved.

Although such process is difficult to generalize, by including its key steps into a matching algorithm, one can greatly improve the accuracy and perceptual relevance of retrieved results. For example, humans are very good at constructing different representations of an object, simplifying them by “picking” the most important characteristics of an object, and using these “simplifications” to drive similarity judgments.

Therefore, in accordance with the concepts of the present invention, at the core of any similarity task is the computation of a perceptual skeleton, a set of points that an observer would “care about”, and then selectively using these perceptual skeletons in, for example, a matching task. Thus, the present invention provides an exemplary general framework for similarity measurement of time domain signals with multiple attributes, although it is noted that the concepts are more general.

That is, it will be clear that the methods of the present invention will be applicable to any ordered sequence and is not confined to signals based on the time domain or even to data based on a regular interval separating the data points. In these cases in which data is not based on time or have irregular intervals, a preliminary conversion might have to be executed to bring the data into a metric space capable of quantitative analysis of the data or possibly to convert analog data into an ordered sequence of discrete data.

The first step in the methodology 100 illustrated in FIG. 1 involves, therefore, transforming signals into a space with a metric (constructing the representation) 101, if necessary, so that operations, such as measuring distances between different points of the signal or identifying local maxima, can be performed.

In step 102, the skeleton of a signal is constructed as being a set of perceptually important points (PIPs) in that space, as will be discussed shortly. In step 103, if necessary for a specific task, dimensions of the skeleton are calculated. In step 104, a distance between two skeletons of different signals can then be used as a similarity measurement.

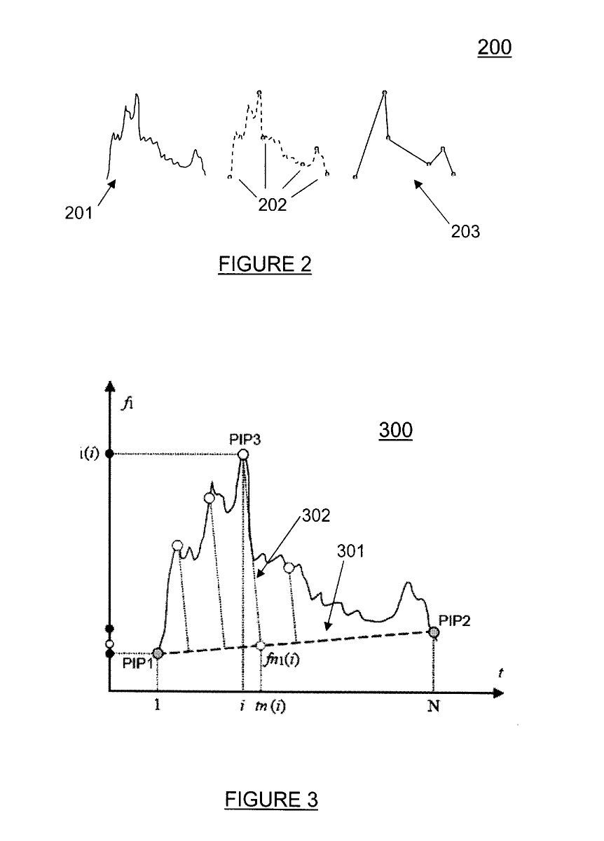

FIG. 2 shows intuitively the concept 200, for an exemplary one-dimensional signal 201, of the PIPs 202 used in the present invention to construct a skeleton 203 obtained by connecting the PIPs 202. Although the present invention concerns primarily time sequences, so that the horizontal axis represents time, it should be apparent that the skeletons of the present invention can be extended to other types of signals and waveforms that have an order to the data.

As a preliminary matter for explaining the mathematics behind the present invention, let us consider two discrete time domain signals, x=[x(t₁), . . . ,x(t_{N}_{ₓ})], and Y=[y(t₁), . . . , Y(t_{N}_{_{y}})], of length Nₓ, and N_{y}, respectively. Each time instance is described with M attributes, x(t)=[x₁(t), . . . ,x_{M}(t)], and y(t)=[y₁(t), . . . ,y_{M}(t)]. Usually the attribute vectors represent different measurements, which are often either strongly correlated, or include features that are distinctly different in nature, so that a distance metric between two attribute vectors cannot be defined naturally.

Therefore, as a first step we apply a de-correlating transform F(·) and project X and Y onto a K-dimensional metric space, S

Fx=F(X)=[fₓ(t₁), . . . , fₓ(t_{N}_{ₓ})],

F_{Y}=F(Y)=[f_{Y}(t₁), . . . , f_{T}(t_{N}_{_{y}})] (1)

where, f(t)=[f₁(t), . . . , f_{K}(t)] and K≦M.

We will also assume that S is a normed linear space with a norm, ∥·∥, and metric d(f_{X}, f_{Y})=∥f_{X}−f_{Y}∥ defined by the norm. It is noted that the goal of the mapping is not dimensionality reduction (although this is a useful step when dealing with highly correlated variables), but the projection of a signal into a space where a metric can be defined more naturally.

This metric will then constitute a local similarity metric, used to identify perceptually skeletons, compute the compression rate and construct a global similarity metric (i.e., a true similarity distance between the two signals).

A body of research in cognitive psychology indicates that humans and animals depend on “landmarks” and “simplifications” in organizing their spatial memory. A subject asked to look at the time sequence 201 of FIG. 2 and duplicate the picture, will typically memorize only the key turning points 202, as shown in the dashed representation, and then recreate the picture 203 by connecting these few points 202.

This idea of perceptually important features has been explored in a variety of applications. One of the first uses of this concept was in reducing a number of points required to represent a line in cartoon making. Similar ideas have also been explored independently.

In the present invention, a perceptually important point (PIP) is defined as a local maximum of the transformed signal F. Depending on the nature of the problem, one can use maxima of different orders.

At the coarsest level, each point in F potentially represents a PIP, and a key exemplary idea behind the perceptual skeletons of the present invention is to discard minor fluctuations and keep only major maxima. One possible PIP identification procedure for one-dimensional signals is described in Fu, et al.

The present invention refines these previous procedures and extends it to handle multi-dimensional feature representations, as exemplarily illustrated in FIG. 3 for an exemplary one-dimensional sequence 300.

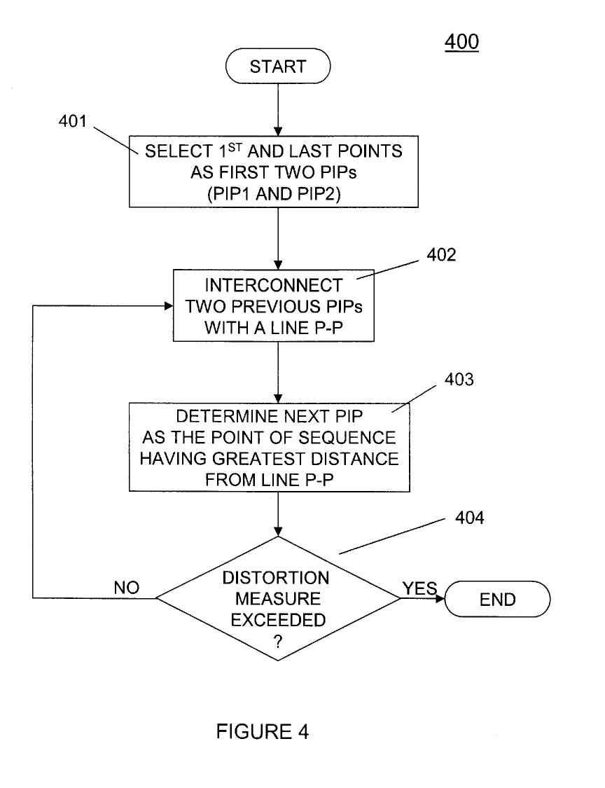

As shown in the flowchart 400 of FIG. 4, we start with the signal representation F=[f(t1), . . . , f(tN)], as shown by sequence 300 in FIG. 3. In step 401, the first and the last points in F are selected as the first two PIPs (e.g., PIP 1 and PIP 2). In step 402, these first two PIPs are interconnected by a line 301. In step 403, every next PIP (e.g., PIP 3) is then identified as a point with the maximum distance 302 to its two adjacent PIPs (e.g., PIP1 and PIP2) from this interconnecting line (e.g., 301). This process can continue until, in step 404, a termination test described later indicates that the skeleton is sufficiently developed.

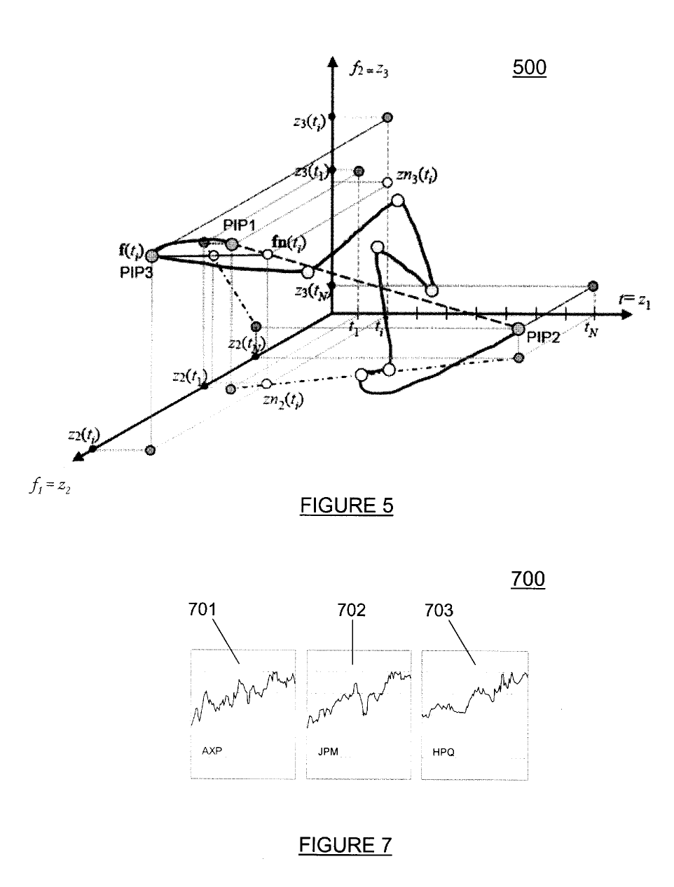

FIG. 5 illustrates represents a generalization to multiple dimensions. The PIP identification procedure can be then described as follows:

$${PIP}_{1} = [ 1 , f ( {t}_{1} ) ] = [ {z}_{1} ( 1 ) , {z}_{2} ( 1 ) , K , {z}_{K + 1} ( 1 ) ] , \\ {PIP}_{2} = [ 2 , f ( {t}_{N} ) ] = [ {z}_{1} ( N ) , {z}_{2} ( N ) , K , {z}_{K + 1} ( N ) ] , \\ {PIP}_{3} = [ i , f ( {t}_{i} ) ] = [ {z}_{1} ( i ) , {z}_{2} ( i ) , K , {z}_{K + 1} ( i ) ] , \\ i = {arg max}_{i} d ( f ( {t}_{i} ) , fn ( {t}_{i} ) ) , and$$

where fn(tᵢ)=[tn(i), fn₁(tᵢ), fn₂(tᵢ), . . . , fn_{K}(tᵢ)]=[zn₁(i), zn₂(i), . . . , zn_{K+1}(i)] is the normal projection of the point f(tᵢ) onto a line connecting the two neighboring PIPs. A line in K+1-dimensional space can be represented as

zᵢ=mᵢ₋₁zᵢ₋₁+nᵢ₋₁, i=2,K ,K+1,

hence, the line connecting pips 1 and 2 is defined by:

$${m}_{i - 1} = \frac{{z}_{i} ( N ) - {z}_{i} ( 1 )}{{z}_{i - 1} ( N ) - {z}_{i - 1} ( 1 )} , \\ {n}_{i - 1} = \frac{{z}_{i} ( N ) - {z}_{i} ( 1 )}{{z}_{i - 1} ( N ) - {z}_{i - 1} ( 1 )} , i = 2 , K , K + 1$$

From now on, we will assume L² norm to be the local similarity metric in the space. In that case, for every point f(tᵢ), fn(tᵢ) can be found by maximizing:

$$D = {\sum }_{j = 1}^{K + 1} {( {z}_{j} ( i ) - {zn}_{j} ( i ) )}^{2} ,$$

subject to znⱼ(i)ε P̅I̅P̅₁̅,̅ P̅I̅P̅₂̅

Using Lagrange multipliers to solve this problem, we obtain fn(tᵢ)=[zn₁(i), zn₂(i), . . . , zn_{K+1}(i)] as a solution to the following system of equations

$${zn}_{1} ( i ) + \frac{1}{2} {λ}_{1} {m}_{1} = {z}_{1} ( i )$$

$${zn}_{j} ( i ) - \frac{1}{2} {λ}_{j - 1} + \frac{1}{2} {λ}_{j} {m}_{j} = {z}_{j} ( i ) , j = 2 , K , K + 1$$

$${zn}_{K + 1} ( i ) - \frac{1}{2} {λ}_{K} = {z}_{K + 1} ( i ) , j = 1 , K , K$$

The PIP identification process continues until a certain distortion measure is satisfied (e.g., step 404 in FIG. 4), or until the number of PIPs is equal to the length of the sequence. The local similarity measure d can be also used as a distortion measure. Assuming original sequence F, compressed sequence Fc, and the sequence interpolated from the compressed version F′, the distortion rate dr can be computed as:

$$dr = \frac{1}{N} {\sum }_{i = 1}^{N} d ( f ( {t}_{i} ) , {f}^{′} ( {t}_{i} ) )$$

As previously mentioned, the skeletons of the present invention can be used for a number of practical application data, including, for example, stock market data and exchange rates, biomedical measurements, weather data, history of product sales, audio, video, etc.

More generally, the present invention allows such functions as recognizing or identifying events or specific sequences, searching for an event or similar event, analyzing a time series, discovering relationships within a time series or between two different time series, categorization of signals into groups or clusters, optimization processing, time-series compression, or indexing of data.

As a point in passing, measurements using the present invention will be different depending on the selection of the starting point and end point. The assumption is that the first and the last point are selected so as to capture the signal of interest or a portion of a signal of interest. It is noted that this is quite similar to how humans perceive the signal.

Taking, for example, a time series of stock prices, one might be interested in the behavior over last year, or over the last month only. Depending on which period is selected the signal, although the same, will look very much different to the observer, as the extreme points or PIPs have an entirely different meaning. However, it should also be clear that, if all signals of interest have the same end points, the resultant perceptual skeletons will be correspondingly related over the period of interest, including corresponding metrics of similarity, even if the perceptual skeletons would change somewhat if another endpoint had been selected.

In the example above, the PIPs represent first-order maxima, since this is how they were defined (e.g., by computing the metric D). However, it is noted that there could be applications where PIPs are defined as second- or higher-order maxima (e.g., if the change in the growth rate, or other discontinuities, were to be the focus).

If a desired task involves determining similarity between two functions X and Y, and the two functions are reduced to their perceptual skeletons Fₛ^{X} and Fₛ^{Y}, the final step is to compute the similarity between the simplified representations.

We will first consider the local similarity metric, d, as a global distance measure. However, as it is often reported, Minkowski-based metrics have drawbacks in comparing time series. Therefore, we will also consider multivariate dynamic time warping (DTW) as an alternative measure.

We start with the perceptual skeletons [fₛ^{X}(t₁), . . . , fₛ^{X}(t_{N}_{ₓ})] and [fₛ^{Y}(t₁), . . . , fₛ^{Y}(t_{N}_{_{y}})], where Nₓ and N_{y} are the number of points in each skeleton, respectively. To compute the similarity measure between the skeletons, we first construct an Nₓ×N_{y} matrix M, where M(i, j)=d(fₛ^{x}(tᵢ),fₛ^{Y}(tⱼ)), and d is the local similarity metric. The warping path, W=w₁, w₂, . . . , w_{L}, where w₁=(i,j)ₜ is a contiguous set of matrix elements that defines a mapping between Fₛ^{X} and Fₛ^{Y}, subject to: boundary conditions w₁=(1,1) and w_{L}=(nₓ,n_{y}), continuity constraint wₖ=(a,b)=>wₖ₋₁=(a′,b′), where a−a′≦1 and b-b′≦1, and monotonicity constraint a-a′≧0 and b-b′≧0. As there are many warping paths that satisfy these conditions, we are interested in finding the path that minimizes the warping cost

$$DTW ( {F}_{s}^{X} , {F}_{s}^{Y} ) = {min}_{W} \sqrt{{\sum }_{l = 1}^{L} M ( {w}_{l} )}$$

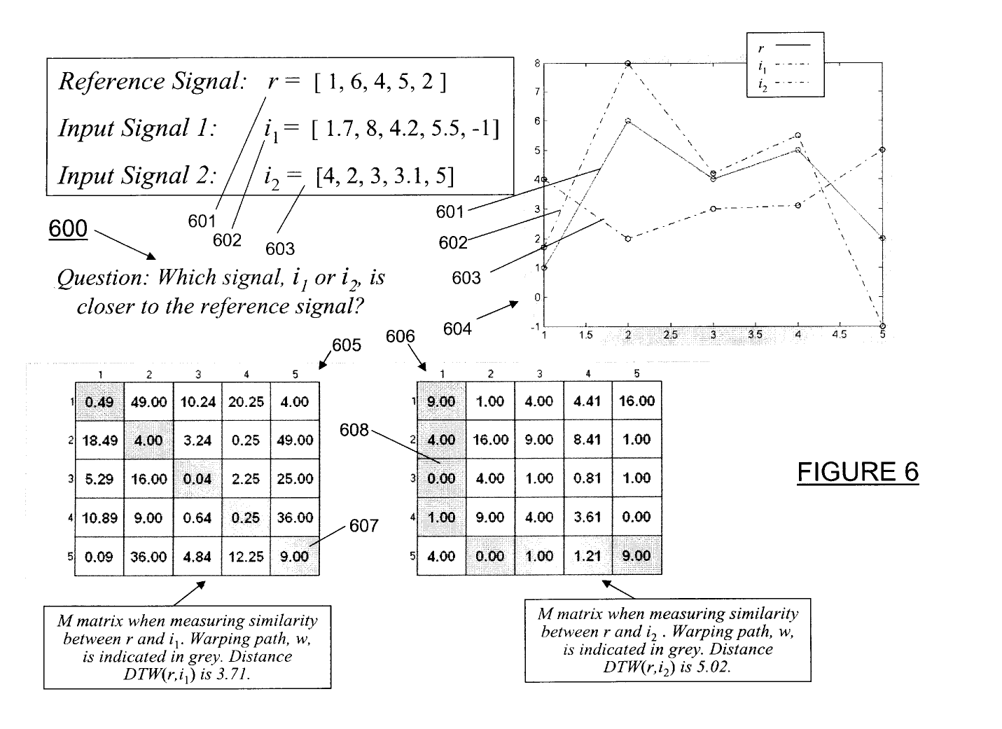

FIG. 6 demonstrates this method of similarity based on N×N matrices and warping paths. Three time-series 601, 602, 603 presumed to have PIPs as identified are shown, and the perceptual skeletons are shown in graph 604. The question of interest 600 is to determine which of the two input signals i₁, i₂ is closer to the reference signal r.

The M matrix 605 shows the M matrix between reference signal 601 and input signal 1 (602). The numbers 1-5 on the left side of the matrix 605 correspond to the five PIPs of the reference signal and the numbers 1-5 across the top correspond to the five PIPs of input signal 1 (602). The numbers in the grids of matrix 605 indicate the vertical distance squared between the two sets of PIPs. The gray grids indicate the warping path and provides similarity measure (e.g., “distance”) of 3.71 between the reference signal and input signal 1. Matrix 606 provides similar information between the reference signal and input signal 2, and the warping path shows a “distance” of 5.02.

The application and performance of the method of the present invention will now be demonstrated in a financial modeling application, using the dataset consisting of 1986-2006 daily stock prices for the DOW Jones Industrial (DJI) index. This index includes 32 stocks.

As first demonstration, a search query is exercised to find a stock having similar time data of the input time data. FIG. 7 shows the result 700 of this search exercise when the query is the stock price series 701 for American Express in a three month period starting on Nov. 14, 2005. Using skeleton representation, the closest match, using both the Euclidean distance and DTW) was found to be the JP Morgan stock price series 702. The closest match using Euclidean distance is the Hewlett Packard stock price series 703.

As a second demonstration of the processing potential of the present invention, we will now consider the following model of the stock market. We will assume a market with Q assets (for our dataset Q=32). Market vectors p(t)=[p₁(t),K, p_{Q}(t)] and r(t)=[r₁(t),K, r_{Q}(t)] are vectors of nonnegative numbers representing asset prices and returns (price relatives) for every trading day.

Let us assume the following simple sequential “momentum” investment strategy. An investor starts investing at time t₀ and rebalances her portfolio every Tᵣ days. The investor can invests all her wealth into only one stock. Let S₀ denote investor's initial capital. Then, at the end of the trading period the investor's wealth becomes:

$${S}_{t} = {\prod }_{t = {t}_{0}}^{{t}_{0} + {T}_{r}} {S}_{0} {r}_{i} ( t )$$

where i is the index of the asset being invested in, since r represents rate expressed as (current price)/(price of previous period).

In order to select the investment for the next trading period, the investor will consider the evolution of the market over Th days prior to the decision time, which is represented by a sequence of price vectors P(t)=[p(t−Th),K,p(t−Th)]. The investor will analyze the stock market history, find a period when the market behaved similarly to the current one, identify the asset that had the highest return in the given period and select that asset as the new investment.

In other words, for every trading period, ti, the investor finds the index of the new investment as

$$ind ( i ) = {arg min}_{j = {t}_{i} - {T}_{h} , K , {t}_{i} - 1} D ( P ( {t}_{i} ) , P ( {t}_{j} ) )$$

and the investor's return after N trading periods becomes

$$R = {S}_{N} / {S}_{0} = {\prod }_{n = 1}^{N} {\prod }_{t = ( N - 1 ) Tr + 1}^{{NT}_{r}} {r}_{ind ( i )} ( t )$$

The sequence of price vectors P(t) is a Q-dimensional time series, where each point represents a market vector at time t. Thus, the present invention can be used to find the most similar past market conditions, and will evaluate the performance of our method by comparing the achieved total return R, to the returns obtained by using the Euclidian distance (ED) and the dynamic time warping (DWT) as similarity metrics between the original signals. We will also compare the performance of the perceptual skeletons with DWT as similarity metric (PS+DWT), with the Euclidean distance as similarity metric (PS+ED). Instead of the distortion rate, we control the quality of the representation via the parameter SLmin, which defines the minimum length of a segment between two PIPs.

Results for the different choices of (Tr,Th, SLmin) shown in the first vertical column of Table 1 below are given in the four right hand columns of the table. The skeleton based representation clearly outperforms the other methods, as demonstrated by the higher returns shown in the second and third columns relative to the returns in the third and fourth columns.

As expected, when used with original signal, DWT in general performs better than ED. However, when using perceptual skeletons, both DWT and ED generate the same returns, indicating that the perceptual representation is robust enough to be used even with the simplest distance measures.

We also observe how the performance of the skeleton representations depends on the compression factor and deteriorates as the representation becomes too coarse (large SLmin, resulting in large distortion rates), or when the simplification is insufficient (too small SLmin, yielding a signal representation that is similar to the original signal).

TABLE 1

| (Tᵣ, Tₕ, SLₘᵢₙ) | PS + DWT | PS + ED | DWT | ED |
|---|---|---|---|---|
| (150, 150, 10) | 1.35 | 1.36 | 1.36 | 1.18 |
| (150, 150, 15) | 2.11 | 2.11 | 1.36 | 1.18 |
| (150, 150, 20) | 2.33 | 2.33 | 1.36 | 1.18 |
| (150, 150, 30) | 1.57 | 1.77 | 1.36 | 1.18 |
| (120, 120, 3) | 1.57 | 1.57 | 1.96 | 1.57 |
| (120, 120, 5) | 2.36 | 2.36 | 1.96 | 1.57 |
| (120, 120, 10) | 2.13 | 2.13 | 1.96 | 1.57 |
| (120, 120, 15) | 2.60 | 2.60 | 1.96 | 1.57 |
| (120, 120, 20) | 2.17 | 2.17 | 1.96 | 1.57 |
| (90, 90, 5) | 2.17 | 2.17 | 1.26 | 2.17 |
| (90, 90, 15) | 2.36 | 2.36 | 1.26 | 2.17 |
| (90, 90, 20) | 1.81 | 1.81 | 1.26 | 2.17 |
| (40, 90, 10) | 2.28 | 2.28 | 1.82 | 2.09 |
| (20, 90, 10) | 2.01 | 1.92 | 1.82 | 1.34 |

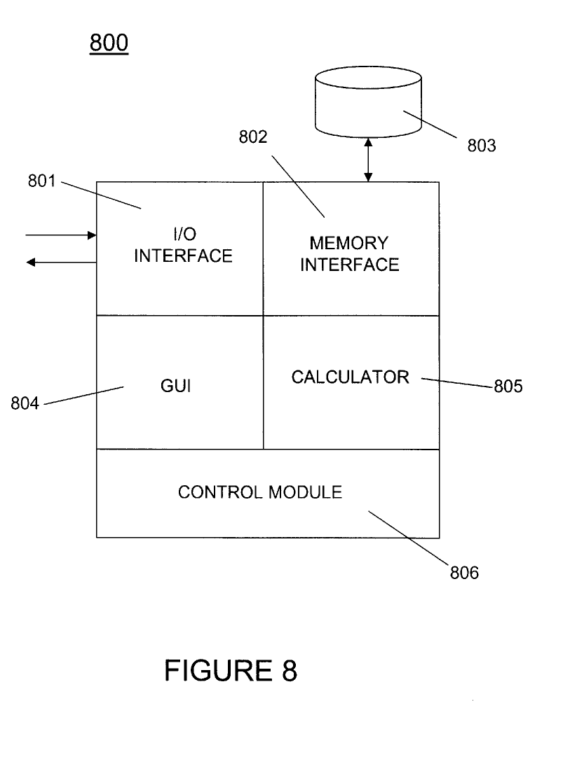

FIG. 8 shows a block diagram 800 of a software-based implementation of the present invention. I/O interface module 801 provides the interface to receive ordered sequence data for processing from an outside source, although such ordered sequence data could also be received via memory interface module 802 from a storage device 803. I/O interface 801 would also receive user inputs from a keyboard or mouse or other input device, in coordination with graphical user interface (GUI) 804, and output results for user display, again in coordination with the GUI module 804.

GUI module 804 would also provide capability of the user to control the software tool, including such tasks, depending upon the function to be performed, as identifying the ordered sequence to be reduced to a skeleton, entry of data such as defining endpoints of the ordered sequence if endpoints are manually entered by the user, defining the termination test and/or parameters for this test, etc.

Calculator module 805 provides the capability to execute the various mathematical procedures for such tasks as calculating the skeleton and similarity values. Control module 806 could be implemented as the main function of an application program, serving to invoke various subroutines related to the other block diagram modules as appropriate.

### Exemplary Hardware Implementation

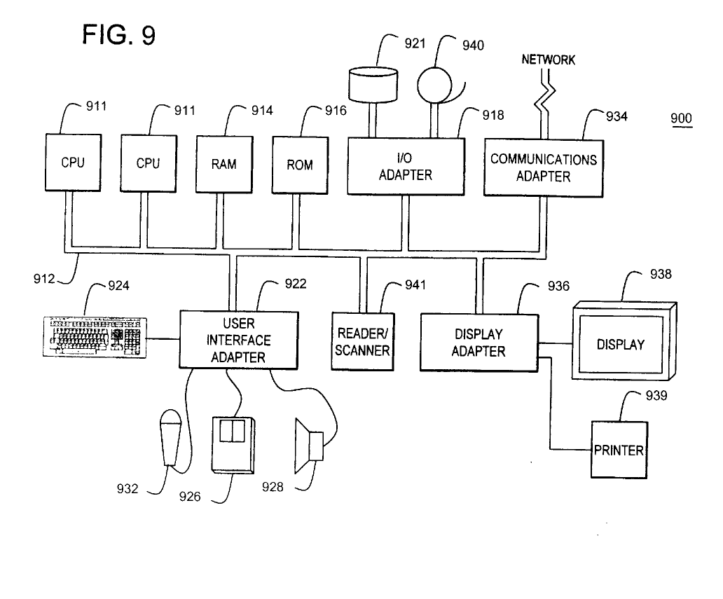

FIG. 9 illustrates a typical hardware configuration of an information handling/computer system in accordance with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 911 and hardware above, to perform the method of the invention.

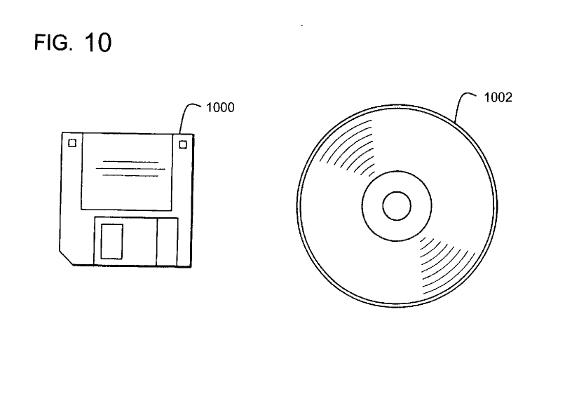

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

From the above discussion, it can be seen that the benefits of the invention include an efficient compression of a time signal (or other ordered sequence), compression and representation in accordance with human visual system, and simplification of the signal for efficient indexing, matching, similarity measurement, and retrieval.

A few non-limiting applications of the present invention include: 1) financial analysis & portfolio optimization; 2) storage, indexing, and searching of medical signals and information, speech, music, seismological signals, weather & climate data; and 3) applications in business analytics and marketing, such as analyzing product lifecycle, looking for products with similar lifecycles, looking for customers with similar behavior over time, etc. However, it should be apparent to one having ordinary skill in the art, having taken the discussion herein as a whole, that the present invention could be applied to any application in which an ordered sequence of data is involved.

In yet another aspect of the present invention, it should be apparent that the method described herein has potential application in widely varying areas for analysis of data, including such as areas as business, manufacturing, government, etc. Therefore, the method of the present invention, particularly as implemented as a computer-based tool, can potentially serve as a basis for a business oriented toward analysis of such data, including consultation services. Such areas of application are considered as covered by the present invention.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described my invention, what I claim as new and desire to secure by Letters Patent is as follows:

1. A computer configured to execute a process of quantifying an ordered sequence of data, said computer comprising:
a data receiver to receive data of said ordered sequence; and
a calculator to determine a skeleton of said ordered sequence,
wherein said skeleton comprises a plurality of perceptually important points (PIPs) of said ordered sequence, as derived by determining one or more points of local maxima of said data over said ordered sequence.

2. The computer of claim 1, wherein said ordered sequence is multivariate.

3. The computer of claim 1, wherein said ordered sequence comprises a time series of data.

4. The computer of claim 1, wherein data of said ordered sequence is preliminarily converted into a metric space when said ordered sequence data is not presented in a manner allowing metric operations on said data.

5. The computer of claim 4, wherein a successive PIP is determined by said calculator by constructing a line between two previous PIPs and a maximum relative to said line is identified for data between said two previous PIPs, to become said successive PIP.

6. The computer of claim 5, wherein successive PIPs are sequentially determined by said calculator until a termination test determines that said skeleton is sufficiently developed.

7. The computer of claim 6, wherein said termination test comprises a local similarity measure.

8. The computer of claim 5, wherein a starting endpoint and an ending endpoint are identified for said ordered sequence of data and said starting and ending endpoints are assigned to be a first PIP and a second PIP for said ordered sequence.

9. The computer of claim 1, said calculator further selectively determining a local similarity metric d for said ordered sequence, for use in determining said PIPs, and a global similarity metric, for use in comparing said skeleton with a skeleton of another ordered sequence.

10. The computer of claim 9, said calculator further processing at least one of the following procedures:
comparing a similarity of said skeleton with a skeleton of another ordered sequence;
searching for similarities within said ordered sequence;
searching for similar ordered sequence in a database;
recognizing or identifying events or specific sequences;
searching for an event or similar event;
analyzing an ordered sequence expressed as a time series;
discovering relationships within a time series or between two different time series;
categorizing signals into groups or clusters;
an optimization processing;
a time-series compression; and
an indexing of data.

11. The computer of claim 10, wherein said procedure involves a time series of financial data.

12. A computerized method of quantifying an ordered sequence of data, comprising:
receiving data of said ordered sequence; and
determining a skeleton of said ordered sequence,
wherein said skeleton comprises a plurality of perceptually important points (PIPs) of said ordered sequence, as derived by determining one or more points of local maxima of said data over said ordered sequence.

13. The method of claim 12, further comprising preliminarily converting said ordered sequence data into a metric space when said ordered sequence data is not presented in a manner allowing metric operations on said data.

14. The method of claim 12, wherein a successive PIP is determined by constructing a line between two previous PIPs and a maximum relative to said line is identified for data between said two previous PIPs, to become said successive PIP.

15. The method of claim 14, wherein successive PIPs are sequentially determined by until a termination test determines that said skeleton is sufficiently developed.

16. The method of claim 12, wherein a starting endpoint and an ending endpoint are identified for said ordered sequence of data and said starting and ending endpoints are assigned to be a first PIP and a second PIP for said ordered sequence.

17. The method of claim 12, said method further selectively:
determining a local similarity metric d for said ordered sequence, for use in determining said PIPs; and
determining a global similarity metric, for use in comparing said skeleton with a skeleton of another ordered sequence.

18. The method of claim 12, said method further comprising at least one of:
comparing a similarity of said skeleton with a skeleton of another ordered sequence;
searching for similarities within said ordered sequence;
searching for similar ordered sequence in a database;
recognizing or identifying events or specific sequences;
searching for an event or similar event;
analyzing an ordered sequence expressed as a time series;
discovering relationships within a time series or between two different time series;
categorizing signals into groups or clusters;
an optimization processing;
a time-series compression; and
an indexing of data.

19. The method of claim 12, as implemented into a service entity that provides consultation service to another entity.

20. A signal-bearing medium tangibly embodying a program of machine-readable instructions executable by a digital processing apparatus to perform a method of quantifying an ordered sequence of data, said method comprising:
receiving data of said ordered sequence; and
determining a skeleton of said ordered sequence,
wherein said skeleton comprises a plurality of perceptually important points (PIPs) of said ordered sequence, as derived by determining one or more points of local maxima of said data over said ordered sequence.
